(19) United States
(12) Patent Application Publication
(10) Pub. No.: US 2023/0064481 A1
(43) Pub. Date: Mar. 2, 2023

(54) RECONFIGURABLE EXECUTION OF MACHINE LEARNING NETWORKS

(71) Applicant: Texas Instruments Incorporated, Dallas, TX (US)

(72) Inventors: Tarkesh PANDE, Richardson, TX (US); Rishabh GARG, Patiala (IN); Pramod Kumar SWAMI, Bengaluru (IN); Kumar DESAPPAN, Bengaluru (IN); Aishwarya DUBEY, Plano, TX (US)

(21) Appl. No.: 17/463,341

(22) Filed: Aug. 31, 2021

(51) Int. Cl. G06N 20/00; G06K 9/62

(52) U.S. Cl. CPC G06N 20/00; G06K 9/6262

(57) ABSTRACT

An electronic device, comprising one or more processors, wherein the one or more processors are configured to execute instructions causing the one or more processors to: receive a machine learning (ML) model and execution information associated with the ML model, wherein the execution information including first execution data indicating how to execute the ML model optimized based on a first performance criterion, and second execution data execution data indicating how to execute the ML model optimized based on a second performance criteria, the second performance criterion different from the first performance criteria; execute the ML model based on the first execution data; determine to execute the ML model based on the second execution data; and execute the ML model based on the second execution data.

### BACKGROUND

Machine learning (ML) is becoming an increasingly important part of the computing landscape. Machine learning is a branch of artificial intelligence (AI), and ML helps enable a software system to learn to recognize patterns from data without being directly programmed to do so. Neural networks (NN) are a type of ML which utilize a set of linked and layered functions (e.g., nodes, neurons, etc.) which are weighted to evaluate input data. In some NNs, sometimes referred to as convolution NNs (CNNs), convolution operations are performed in NN layers based on inputs received and weights rather than matrix multiplication used in traditional NN. Layers in CNNs may perform many types of functions, including, but not limited to, convolution, deconvolutional, pooling, up-sample, etc. CNNs are often used in a wide array of applications typically for recognition and classification, such as image recognition and classification, prediction and recommendation systems, speech and language recognition and translation, etc.

As ML becomes increasingly useful, there is a desire to execute complex ML techniques, such as NNs and CNNs, efficiently in devices with relatively limited compute and memory resources, such as embedded, or other low-power devices, To help efficiently run a given ML model, the ML model may be analyzed and optimized to tailor how the ML model is run to a target hardware resources to be used.

### SUMMARY

This disclosure relates to an electronic device, comprising one or more processors. The one or more processors are configured to execute instructions causing the one or more processors to: receive a machine learning (ML) model and execution information associated with the ML model, wherein the execution information including first execution data indicating how to execute the ML model optimized based on a first performance criterion, and second execution data execution data indicating how to execute the ML model optimized based on a second performance criteria, the second performance criterion different from the first performance criteria. The processors are further configured to execute instructions causing the one or more processors to execute the ML model based on the first execution data. The processors are further configured to execute instructions causing the one or more processors to determine to execute the ML model based on the second execution data and execute the ML model based on the second execution data.

Another aspect of the present disclosure relates to a method. The method includes receiving a machine learning (ML) model and execution information associated with the ML model, wherein the execution information including first execution data indicating how to execute the ML model optimized based on a first performance criterion, and second execution data execution data indicating how to execute the ML model optimized based on a second performance criteria, the second performance criterion different from the first performance criteria. The method further includes executing the ML model based on the first execution data. The method further includes determining to execute the ML model based on the second execution data. The method further includes executing the ML model based on the second execution data.

Another aspect of the present disclosure relates to a non-transitory program storage device comprising instructions stored thereon to cause one or more processors to receive a machine learning (ML) model. The instructions further cause the one or more processors to generate first execution data for executing the ML model on target hardware, the first execution data indicating how to execute the ML model on the target hardware optimized based on a first performance criterion. The instructions further cause the one or more processors to generate a second execution data for executing the ML model on target hardware, the second execution data indicating how to execute the ML model on the target hardware optimized based on a second performance criteria, the second performance criteria different from the first performance criterion. The instructions further cause the one or more processors to output the first execution data and second execution data for executing the ML model

### BRIEF DESCRIPTION OF THE DRAWINGS

For a detailed description of various examples, reference will now be made to the accompanying drawings in which:

FIG. 1 illustrates an example NN ML model, in accordance with aspects of the present disclosure.

FIG. 2 is a block diagram of a device, including hardware for executing ML models, in accordance with aspects of the present disclosure.

FIG. 3 is a conceptual diagram illustrating an example optimization for a ML model, in accordance with aspects of the present disclosure.

FIG. 4 is a block diagram overviewing a process for compiling and optimizing ML models for target hardware, in accordance with aspects of the present disclosure.

FIG. 5 is a chart plotting optimization solutions based on factors, in accordance with aspects of the present disclosure.

FIG. 6 is a flowchart illustrating reconfiguring ML model execution, in accordance with aspects of the present disclosure.

FIG. 7 is a flowchart illustrating a technique for adapting execution of an ML model, in accordance with aspects of the present disclosure.

FIG. 8 is a flowchart illustrating a technique for determining adaptations for executing an ML model, in accordance with aspects of the present disclosure.

### DETAILED DESCRIPTION

As ML has becoming more common and powerful, hardware, such as embedded device, have configured to execute ML models has been introduced. As used herein, an ML model may refer to an implementation of one or more ML algorithms which model a behavior, such as object recognition, behavior of a circuit, behavior of a neuron, etc. In cases where a target hardware for executing ML models is known, the ML models may be optimized for the target hardware configurations to help enhance performance. For example, ML models for object recognition, low-light enhancement, and facial recognition may be optimized to execute on a particular a mobile device, such as a smartphone configured with a certain ML processor. As another example, ML models for object recognition, movement prediction, and behavioral prediction may be optimized to execute on specific hardware (e.g., target hardware) found in some partially or fully self-driving automobiles. In some cases, a ML model may be optimized in multiple times for multiple, different, aspects for the target hardware. During execution of the ML model on the target hardware, the execution of the ML model may be adjusted based on the different optimizations.

Example ML Model

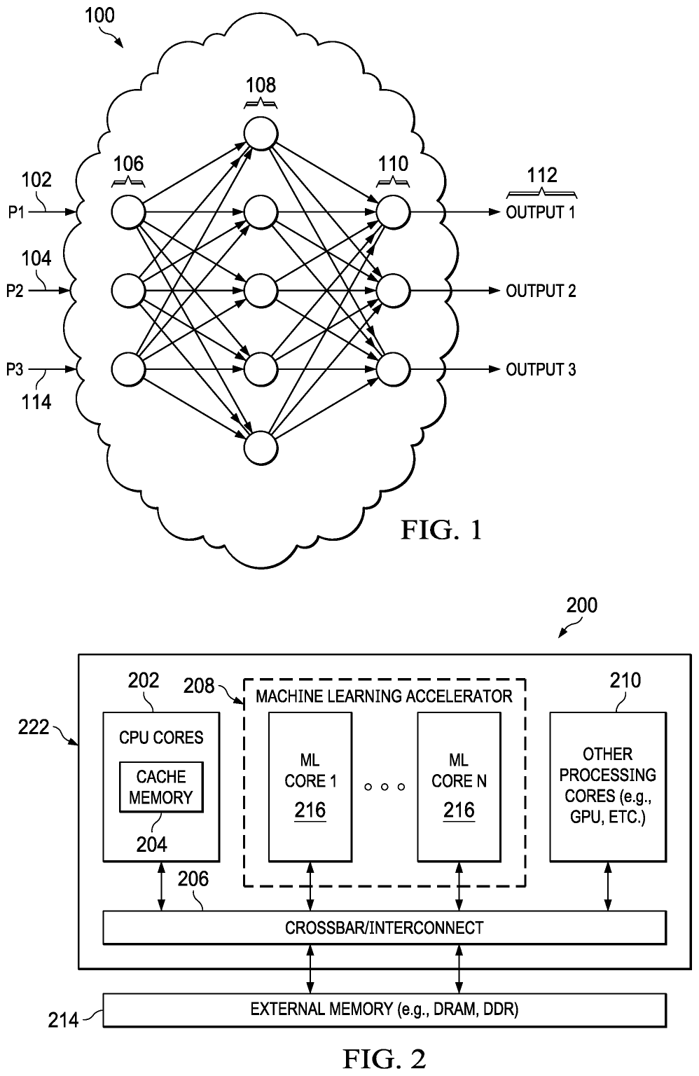

FIG. 1 illustrates an example NN ML model 100, in accordance with aspects of the present disclosure. The example NN ML model 100 is a simplified example presented to help understand how an NN ML model 100, such as a CNN, is structured and trained. Examples of NN ML models may include LeNet, Alex Net, Mobilnet, etc. It may be understood that each implementation of an ML model may execute one or more ML algorithms and the ML model may be trained or tuned in a different way, depending on a variety of factors, including, but not limited to, a type of ML model being used, parameters being used for the ML model, relationships as among the parameters, desired speed of training, etc. In this simplified example, parameter values of P1, P2, and P3 are parameter inputs 102, 104, and 114, which are passed into the ML model 100. Each layer (e.g., first layer 106, second layer 108, and third layer 110) includes a plurality of nodes (e.g., neurons) and generally represents a set of operations performed on the parameters, such as a set of matrix multiplications, convolutions, deconvolutions, etc. For example, each node may represent a mathematical function that takes, as input (aside from the nodes of the first layer 106), output from a previous layer and a weight. The ML model outputs 112 are output from the last layer (e.g., the third layer 110). The weight is typically adjusted during ML model training and fixed after the ML model training. The specific mathematical function of the node can vary depending on ML model implementation. While the current example addresses three layers, in some cases the ML model may include any number of layers. Generally, each layer transforms M number of input parameters to N number of output parameters. The parameter inputs to the first layer 106 are output as inputs to the second layer 108 with a set of connections. As each node of a layer (such as first layer 106) outputs to each node in a subsequent layer (such as second layer 108), ML model 100 is a fully connected NN. Other embodiments may utilize a partially connected NN or another NN design which may not connect each node of a layer to each node of a subsequent layer, where some node connections may skip layers, where no feedback is provided from output to inputs (e.g., Feed Forward CNN), etc.

In this example, first layer 106 represents a function based on a set of weights that are applied to the input parameters (e.g., input parameters 102 and 104) to generate output from first layer 106 that is input to the second layer 108. Different weights may be applied for the input received from each node of the previous layer by the subsequent layer. For example, for a node of the second layer 108, the node applies weights to input received from nodes of the first layer 106 and the node may apply a different weight to input received from each node of the first layer 106. Nodes compute one or more functions based on the inputs received and corresponding weights and outputs a number. In some cases, inputs and output to an ML model layer may be referred to as input or output features of the ML model layer. For example, the node may use a linear combination function which multiplies an input values from a node of the previous layer with a corresponding weight and sums across the results of the multiplication, coupled with a non-linear activation function which acts as a floor for the resulting number for output. It may be understood that any known weighted function may be applied by the node within the scope of this disclosure. This output number may be input to subsequent layers, or if the layer is a final layer, such as third layer 110 in this example, the number may be output as a result (e.g., output parameters or ML model outputs 112).

In some cases, the functions applied by nodes of a layer may differ as between layers. In some cases, each layer may have different resource requirements. For example, when the functions of multiple nodes are performed by a processor, the different functions may have different loads on the processor. Additionally, some functions may have different input or output parameters and thus consume more, or less, memory space and bandwidth. These differing processor and memory loads may also influence an amount of energy to power the processor and memory, as well as an amount of heat generated.

After an ML model, such as NN ML model 100, is defined with respect to nodes, layers, etc., the ML model may be trained. In some cases, the ML model 100 may be trained using a labelled data set corresponding to data to be input to ML model 100. For example, an object recognizer may be trained on images of objects. These images may include metadata labelling the object(s) in the image. The ML model 100 may be initiated with initial weights and the images input to the ML model 100 to generate predictions. The weights of the nodes may be adjusted based on how accurate the prediction is as compared to the labels. The weights applied by a node may be adjusted during training based on a loss function, which is a function that describes how accurately the predictions of the NN are as compared to the expected results; an optimization algorithm, which helps determine weight settings adjustments based on the loss function; and/or a backpropagation of error algorithm, which applies the weight adjustments back through the layers of the NN. Any optimization algorithm (e.g., gradient descent, mini-batch gradient descent, stochastic gradient descent, adaptive optimizers, momentum, etc.), loss function (e.g., mean-squared error, cross-entropy, maximum likelihood, etc.), and backpropagation of error algorithm (e.g., static or recurrent backpropagation) may be used within the scope of this disclosure.

In some cases, training the ML model 100 is performed during development of the ML model 100 and may be performed by a system or device separate from the system or device that runs the trained ML model.

Example Hardware for Executing ML Models

FIG. 2 is a block diagram 200 of a device, including hardware for executing ML models, in accordance with aspects of the present disclosure. The device may be system on a chip (SoC), including multiple components configured to perform different tasks. As shown, the device includes one or more central processing unit (CPU) cores 202, which may include one or more internal cache memories 204. The CPU cores 202 may be configured for general computing tasks.

The CPU cores 202 may be coupled to a crossbar (e.g., interconnect) 206, which interconnects and routes data between various components of the device. In some cases, the crossbar 206 may be a memory controller or any other circuit that can provide an interconnect between peripherals. Peripherals may include master peripherals (e.g., components that access memory, such as various processors, processor packages, direct memory access (DMA)/input output components, etc.) and slave peripherals (e.g., memory components, such as double data rate (DDR) random access memory, other types of random access memory, DMA/input output components, etc.). In some cases, the processing cores, such as CPU cores 202, ML accelerator 208, and other processing cores 210 and crossbar 206 may be integrated on a single chip, such as a SoC 222 with a separate external memory. In this example, the crossbar 206 couples the CPU cores 202 with other peripherals, such as an ML accelerator 208 and other processing cores 210, such as a graphics processing unit, radio basebands, coprocessors, microcontrollers, etc., and external memory 214, such as DDR memory, dynamic random access memory (DRAM), flash memory, etc., which may be on a separate chip from the SoC. The crossbar 206 may include or provide access to one or more internal memories that may include any type of memory, such as static random-access memory (SRAM), flash memory, etc. The ML accelerator 208 may include one or more ML cores 216. The ML cores 216 may be processor cores configured to accelerate machine learning models and the ML cores 216 may include one or more internal caches (not shown).

In some cases, the device may be an embedded device which is built into another device and may perform a specific function for the other device. Often embedded devices are resource constrained with a relatively limited amount of compute and memory resources. To help improve the performance of a ML model on target hardware, such as for the embedded device, execution of the ML model may be optimized for the target hardware. Various specific optimizations may be applied.

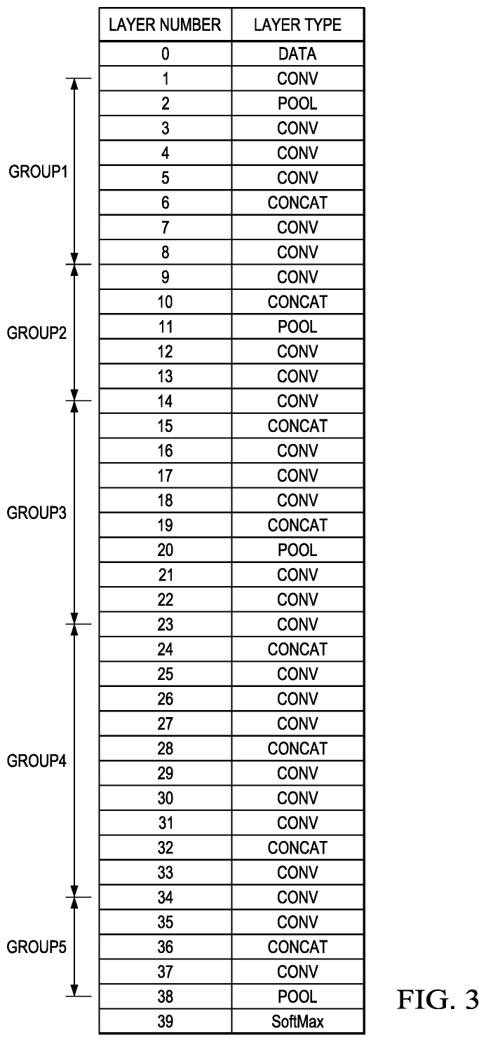

FIG. 3 is a conceptual diagram 300 illustrating an example optimization for a ML model, in accordance with aspects of the present disclosure. In this example optimization technique, as shown in diagram 300, layers of a ML network may be divided into multiple groups. As shown, the groups may each include a different number of layers. For example, group 1 302 may include 9 layers, while group 2 304 may include 6 layers. Each group of layers may be processed at once by the target hardware. In this example optimization technique, the ML model may be optimized for target hardware by determining which layers may grouped for execution together. Additional examples of optimization techniques which utilize various groups of layers of a ML model are discussed in U.S. patent application Ser. No. 17/327,869 and U.S. patent application Ser. No. 16/797,871, both of which are hereby incorporated by reference.

As discussed above, when a ML model is executed on a processor, the processor typically performs a set of computations based on parameter values input to the ML model along with weights, functions, etc. associated with the ML model. Each node of a layer of the ML model may be associated with a different set of weights, combination functions, activation function, etc., that may be loaded from a memory into the processor for the calculations to be performed. Generally, the closer a memory is to the processor, the faster the processor can retrieve information from the memory. Generally, the faster the processor can retrieve the information from the memory, the faster the processor can perform the calculation. In many cases, cache memory, such as internal cache memory 204 is closer to the processor than an external memory, such as external memory 214 and executing the ML model from the internal cache memory 204 (e.g., retrieving information from the internal cache memory for the processor) is faster than executing from the external memory 214. However, a size of the cache memory is more limited as compared to the size of the external memory.

Conventionally, information associated with nodes of a layer may be loaded, for example, from the external memory into cache memory and then executed from the cache memory. Output from the computations of the layer may also be stored into external memory and reloaded into the cache memory for execution of the next layer. To help avoid loading each layer from external memory, groups of layers, or portions of layers, may be defined for loading into and executing from cache memory. Additionally, storing the output results of the computations for a layer into the cache memory also helps improve performance as compared to storing the output results in the external memory as the output results for a layer are often used as input for the next layer. Techniques to group multiple portions of layers along with output results of these groups are discussed, for example, in discussed in U.S. patent application Ser. No. 17/327,869 and U.S. patent application Ser. No. 16/797,871.

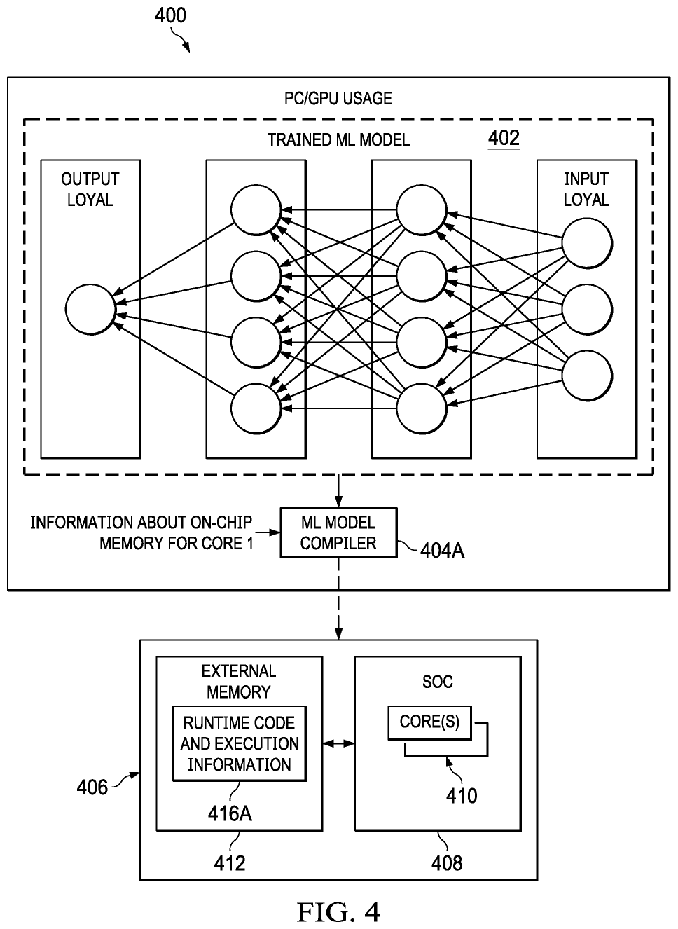

FIG. 4 is a block diagram 400 overviewing a process for compiling and optimizing ML models for target hardware, in accordance with aspects of the present disclosure. A machine learning model 402 is trained during a training phase of development of the respective ML model 402. Training an ML model 402 teaches the ML model to perform a task. For example, an ML model 402 for object recognition may be trained by presenting the ML model 402 with labeled images, including an object, letting the ML model 402 attempt to identify the object in the image, and then adjusting parameters of the ML model 402, such as weights for layers of the ML model 402, based on how well the ML model 402 recognized the object.

Once an ML model is trained, the ML model 402 may be compiled and/or prepared for a target hardware by an ML model complier 404. It may be understood that the compilation process may include multiple processes, steps, operations, etc., which may be performed separately, and/or in an automated fashion. In this example, the target hardware 406 is shown as a simplified version of the device shown in FIG. 2, and the target hardware 406 includes a SoC 408 with one or more cores 410. The SoC 408 is also coupled to external memory 412. The ML model compiler 404 helps prepare the ML model 402 for execution by the target hardware 406 by translating the ML model 402 to a runtime code and execution information 416 that is compatible with the target hardware 406.

It may be understood that the compilation process may include multiple sub-processes. In some cases, in addition to translating the ML model 402 to runtime code, the compilation process may also include one or more sub-processes analyzing execution of the ML model 402 and/or optimizing execution of the ML model 402 on the target hardware 406. In some cases, simulations may be performed after the ML model is trained and as a part of preparing the trained ML model 402 for execution on the target hardware 406. For example, as a part of the compilation and/or translation process, ML model execution on the target hardware 406 may be simulated. In some cases, the simulation of the ML model execution may be performed as a separate process from the compilation/translation process. These simulations may be performed as a part of an optimization process. For example, execution of the ML model using different groupings of the layers of the ML model may be simulated to help identify groupings of layers of the ML model which help improve the performance of the ML model executing on the target hardware 406. In some cases, all possible groupings of the layers of the ML model may be simulated to identify the grouping which optimizes performance of the ML model on the target hardware 406.

Often optimizing for performance on the target hardware 406 is defined by execution times. That is, the optimization process often seeks the lowest execution time for the ML model for the target hardware 406. Of note, the lowest execution time may be described by a variety of metrics, such as frames per second analyzed, minimum amount of computing cycles required to run the ML model against a number of inputs, etc.

In some cases, the optimization process may identify multiple optimization solutions, such as a particular grouping of layers, based on two or more factors. Often it is assumed that optimizing for lowest execution time includes optimizing for certain other factors, such as external memory bandwidth usage. For example, it is often assumed that optimizing for the lowest execution time will automatically result in the lowest amount of external memory bandwidth usage. For some ML models, optimizing for the lowest execution time does minimize the amount of external memory bandwidth needed. For some ML models, there may be a unique solution which minimizes the execution time and another solution which minimizes the amount of external memory bandwidth needed. Additionally, other solutions may offer differing trade-offs between the execution time and the amount of external memory bandwidth needed. These solutions may be considered as forming a pareto-optimal frontier of solutions. In some cases, it may be beneficial to offer different solutions along the pareto-optimal frontier of solutions, for example, to allow more precise tuning of the execution of the ML model.

It should be understood that this example optimization process described herein was chosen for clarity and simplicity purposes and it should be understood that any other optimization technique may be applied to the concepts described herein.

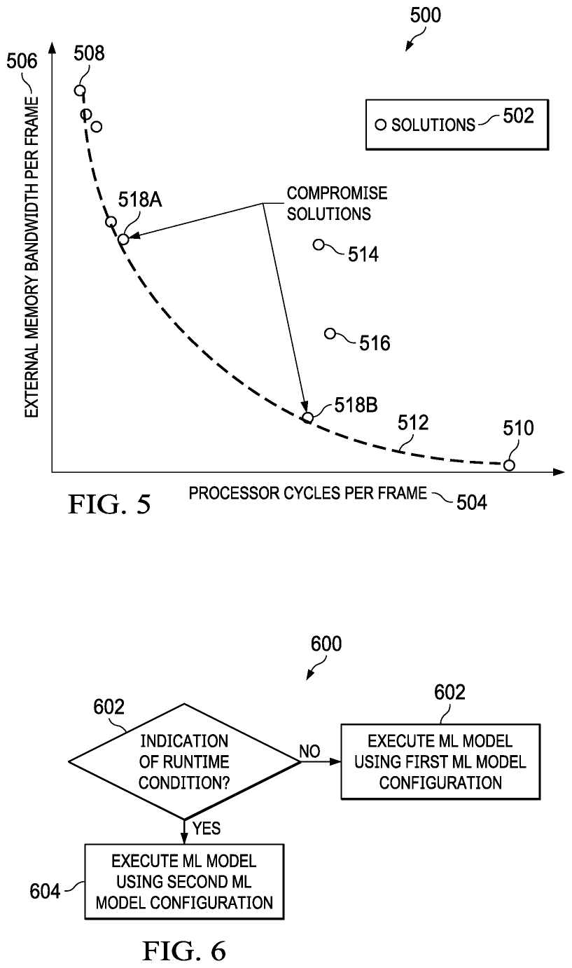

As an example, graphically plotting the solutions that may be obtained, during an optimization process, by simulating the ML model can help illustrate how different solutions along the pareto-optimal frontier of solutions may be selected. FIG. 5 is a chart 500 plotting optimization solutions based on factors, in accordance with aspects of the present disclosure. As shown, chart 500 includes a set of solutions 502 plotted with respect to two factors arranged on two axes. In this example, the optimization solutions shown may represent different groupings of layers of the ML model. To aid clarity and understanding, it may be assumed that the points shown in FIG. 5 represent all possible optimization solutions (e.g., all possible groupings of layers of the ML model). It may be understood that there may be any number of optimization solutions. In some cases, the possible optimization solutions may be exhaustively simulated, while in other cases, the possible optimization solutions may be simulated until a predefined stopping point is reached.

Each solution may be evaluated, for example as a part of the simulation, based on a set of factors. In this example, the factors include a number of processor cycles used per frame 504 to execute the ML model on the target hardware, as plotted on the X-axis, and an amount of external memory bandwidth used per frame 506, as plotted on the Y-axis. For some ML models, a best performing solution with respect to one factor may not be the best performing solution with respect to another factor. Here, a first solution 508 (e.g., grouping of the ML layers) may use less computing cycles than other solutions of the set of solutions 502. The first solution 508 may be identified by determining the solution, of a set of solutions, having the lowest number of used processor cycles per frame. In this example, the first solution 508 may also use more external memory bandwidth per frame 506 than a second solution 510. In this example, the first solution 508 represents the optimized solution for the first factor (e.g., lowest execution time/minimum processor cycles) on the target hardware and the second solution 510 represents the optimized solution for the second factor (e.g., external memory bandwidth) on the target hardware. The second solution 510 may be identified by determining the solution, of a set of solutions, having the lowest external memory bandwidth usage. Thus, when optimizing based on the first and second factors, the optimization process may identify these two optimized solutions.

In some cases, certain solutions of the set of solutions 502 may form a pareto frontier 512 such that no one factor may be improved upon without making another factor worse off. Thus, in this example, for solutions on the pareto frontier 512, any reductions in an amount of processor cycles used per frame 504 results in an increase in an amount of external memory bandwidth user per frame 506. In some cases, solutions on a pareto optimal frontier 512 may be determined. Solutions on the pareto optimal frontier 512 may be determined by comparing an evaluated solution to the other solutions to determine whether any other solution improves on the evaluated solution in every dimension (e.g., factors). For example, both the first solution 508 and the second solution 510 are on the pareto optimal frontier 512 as no other solution has a lower number of used processor cycles for the first solution 508, and no other solution has a lower amount of external memory bandwidth usage for the second solution 510. As another example, when evaluating evaluated solution 514 and 516, these evaluated solutions 514 and 516 may be compared with other solutions including solution 518. Solution 518 has both a lower number of used processor cycles and a lower amount of external memory bandwidth usage than both evaluated solution 514 and 516. Thus, solution 518 strictly dominates both evaluated solution 514 and 516 and evaluated solution 514 and 516 are not solutions on the pareto optimal frontier 512. In contrast, solution 518 is not strictly dominated by any other solution. While the second solution 510 may have a lower amount of external memory bandwidth usage as compared to solution 518, the second solution 510 uses a higher number of processor cycles. Similarly, the first solution 508 may have a lower number of used processor cycles per frame as compared to solution 518, the first solution 508 uses a larger amount of external memory bandwidth.

Additionally, one or more compromise solutions may also be identified by the optimization process. These compromise solutions may represent solutions that trade-off between two or more factors. For example, some solutions of the set of solutions 502 may use relatively more computing cycles, but less external memory bandwidth, than the first solution 508 and less computing cycles, but more external memory bandwidth than the second solution 510. In some cases, these compromise solutions may fall between the solutions most optimized for a particular factor (e.g., the first solution 508 and second solution 510). One or more compromise solutions may be selected from solutions on the pareto frontier 512. In some cases, these compromise solutions may be selected from solutions on the pareto frontier 512 which minimize the distance between the solution, as plotted against the factors, and a hypothetical perfect solution (e.g., 1 processor cycle, no external memory bandwidth used). When optimizing based on the first and second factors, the optimization process may identify, in addition to the two optimized solutions, one or more of the selected compromise solutions.

In some cases, compromise solutions may be identified based on a range. Ranges may be defined based on the best performing solutions for the factors. As an example, a first range from the first solution 508 may be defined and a second range from the second solution 510 may also be defined. The first range and the second range may be predefined or defined at run time, such as by a user. The first range and the second range may be the same or different. As an example, the first range may be a value range, such as within 10%, for the factor that the first solution 508 is the best performing solution for. Thus, pareto frontier solutions having several used processor cycles per frame within 10% of the number of used processor cycles per frame of first solution 508 may be selected as a first set of candidate compromise solutions. Of this first set of candidate compromise solutions, the solution with the best performance with respect to the other factor (here, the least amount of external memory bandwidth used per frame) may be selected as a compromise solution 518A. Similarly, the second range may be a value range, such as 10%, for the factor that the second solution 510 is the best performing solution for. Thus, pareto frontier solutions having an external memory bandwidth usage per frame within 10% of the external memory bandwidth usage per frame of the second solution 510 may be selected as a second set of candidate compromise solutions. Of these second set of candidate compromise solutions, the solution with the best performance with respect to the other factor (here, the least number of used processor cycles per frame) may be selected as a compromise solution 518B.

Once the optimized/compromise solutions are identified, the solutions may be provided to the target hardware for use when executing the ML model, for example, as a part of the execution information. Returning to the example discussed above, the execution information may include an indication of a plurality of groupings of the layers and an indication of a factor associated with the grouping. This indication of a factor may be implicit or explicit. For example, the indication of the factor may be implicit based on an ordering of the groupings of the layers where the first layer grouping may be the layer grouping optimizing for a first factor, a second layer grouping, in the order, may be the layer grouping optimizing for the second factor, and so forth. In some cases, implicit indication of a factor may be predefined. As an example of explicitly indicating a factor, the execution information may include a metadata and/or a tag indicating which grouping is associated with which factor, or when to use a particular grouping. The execution information may be provided to the target hardware along with runtime code associated with the ML model.

FIG. 6 is a flowchart 600 illustrating reconfiguring ML model execution, in accordance with aspects of the present disclosure. In some cases, the target hardware may adjust the execution of the ML model based on the execution information and one or more run-time factors. As an example, a ML model may be used for object detection and operate on frames of a video stream received from a camera, executing many times per second, for example 60 times per second while the target hardware is operating.

As shown, the ML model may be associated with execution information indicating two ML model optimization configurations. In this example, a first ML model configuration may be optimized for a lower number of processor cycles (or lower execution time) as compared to a second ML model configuration, which may be optimized for a lower external memory bandwidth usage. The target hardware may be configured to determine whether a particular runtime condition has been met 602 prior to a next execution of the ML model. For example, the target hardware may be configured to determine whether a certain percentage or amount of external memory bandwidth is already in use, whether there are external memory access stalls occurring, memory bus temperatures out of a certain range, etc. Other runtime conditions may include a temperature of one or more portions of the target hardware, an amount of power used (or available for use) by the target hardware, an amount of processor compute cycles used (or available for use), etc. If such a runtime condition exits, the target hardware may execute the ML model, for example during the next execution of the ML model, based on the second ML model configuration 604. For example, if the certain percentage of external memory is already in use, the target hardware may execute the ML model using the second ML model configuration by setting a flag/parameter, passing the ML model configuration information associated with the second ML model configuration, etc. As a more specific example, external memory bandwidth of the target device may be limited and if another process is already using sufficient external memory bandwidth such that execution of the ML model using the first ML model configuration would be impacted by the external memory bandwidth available, then the target hardware may execute the ML model using the second ML model configuration. In some cases, multiple runtime conditions may be defined. For example, if the certain percentage of external memory is already in use or if there are external memory access stalls, then the target hardware may execute the ML model based on the second ML model configuration 604.

If such a runtime condition does not exit, then the target hardware may execute the ML model based on the first ML model configuration 604. For example, if the certain percentage of external memory is not already in use, the target hardware may execute the ML model using the first ML model configuration. In some cases, the ML model may default to the first ML model configuration unless an indication that the ML model should be executed using the second ML model configuration is received.

In some cases, the execution information may include information for configuring the target hardware to adjust the execution of the ML model based on the execution information. For example, the execution information may include instructions (e.g., software) for execution on the target hardware to configure the target hardware to determine whether a particular runtime condition has been met and/or instructions for how to execute the ML model using the various ML model configurations.

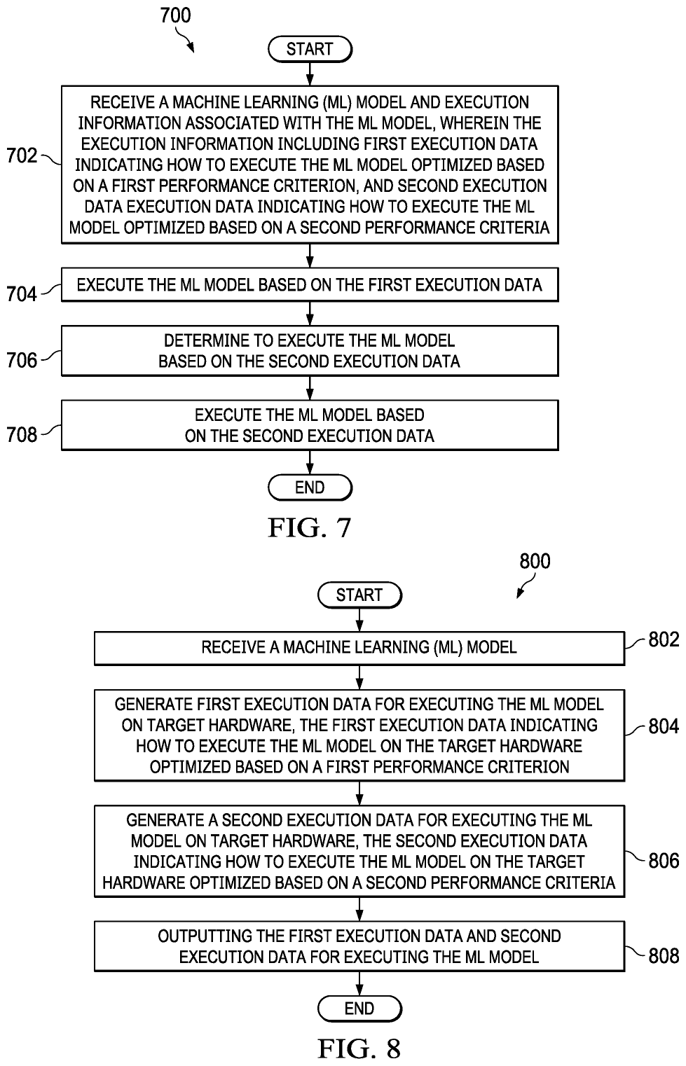

FIG. 7 is a flowchart 700 illustrating a technique for adapting execution of an ML model, in accordance with aspects of the present disclosure. At block 702, a machine learning (ML) model and execution information associated with the ML model is received. The execution information includes first execution data indicating how to execute the ML model optimized based on a first performance criterion, and second execution data execution data indicating how to execute the ML model optimized based on a second performance criteria, where the second performance criterion is different from the first performance criteria. For example, target hardware may receive a ML model for execution on the target hardware along with execution information associated with the ML model. The execution information may include information indicating how to execute the ML model. This execution information may optimize the ML model for execution on the target hardware. For example, the execution information may include information for grouping the layers of the ML model for execution. This grouping may be predetermined, for example during a ML model compilation process for the target hardware. The execution information may optimize the execution of the ML model for multiple performance criterion, such as execution time, memory bandwidth used, etc. For example, a particular grouping of the ML layers may configure the ML model to execute in a fewest number of processor cycles. Another grouping of the ML layers may configure the ML model to execute using a lowest amount of memory bandwidth.

At block 704, the ML model is executed based on the first execution data. For example, the ML model may execute using a particular set of execution information. As a more specific example, the ML model may execute using execution information optimizing the ML model to execute in the fewest number of processor cycles. In some cases, a particular set of execution information may be a default configuration. At block 706, a determination is made to execute the ML model based on the second execution data. For example, the target hardware may monitor one or more runtime conditions. If one or more of these runtime conditions are met, the target hardware may determine to execute the ML model based on the second execution data. For example, if the target hardware determines that a certain amount of memory bandwidth is in use, then the target hardware may determine to alter the way the ML model is executing to help reduce the amount of memory bandwidth used by the ML model. As a more detailed example, the target hardware may determine to execute the ML model using a grouping of the ML model layers which executes using a lowest amount of memory bandwidth. At block 708, the ML model is executed based on the second execution data. For example, the target hardware may then execute the ML model again using the grouping of the ML model layers which executes using a lowest amount of memory bandwidth.

FIG. 8 is a flowchart 800 illustrating a technique for determining adaptations for executing an ML model, in accordance with aspects of the present disclosure. At block 802, a machine learning (ML) model is received. For example, a ML model may be received for compilation for target hardware. In some cases, the ML model may be compiled for the target hardware by a computing device, such as a personal computer, server, network of computing devices, etc., separate from the target hardware. At block 804, first execution data for executing the ML model on target hardware is generated, the first execution data indicating how to execute the ML model on the target hardware optimized based on a first performance criterion. For example, the compilation process may include an optimization process which optimizes the ML model for execution on the target hardware based on certain performance criterion, such as execution time, memory bandwidth used, etc. In some cases, the optimization process may include simulating the execution of the ML model on the target hardware using various configurations to help determine how the respective configuration performs as against the performance criterion. At block 806, second execution data for executing the ML model on target hardware is generated, the second execution data indicating how to execute the ML model on the target hardware optimized based on a second performance criteria, the second performance criteria different from the first performance criterion. For example, the optimization process may optimize the ML model based on a plurality of performance criterion. At block 808, the first execution data and second execution data are output for executing the ML model.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Modifications are possible in the described embodiments, and other embodiments are possible, within the scope of the claims.

What is claimed is:

1. An electronic device, comprising:
one or more processors, wherein the one or more processors are configured to execute instructions causing the one or more processors to:
receive a machine learning (ML) model and execution information associated with the ML model, wherein the execution information including first execution data indicating how to execute the ML model optimized based on a first performance criterion, and second execution data execution data indicating how to execute the ML model optimized based on a second performance criteria, the second performance criterion different from the first performance criteria;
execute the ML model based on the first execution data;
determine to execute the ML model based on the second execution data; and
execute the ML model based on the second execution data.

2. The electronic device of claim 1, wherein the first performance criterion comprises an execution time of the ML model on the target hardware, and wherein the second performance criterion comprises a memory access bandwidth.

3. The electronic device of claim 1, wherein the indication to execute the ML model based on the second execution data comprises the second execution data.

4. The electronic device of claim 1, wherein the instructions further configure the one or more processors to monitor a runtime condition, wherein the determination to execute the ML model is based on the monitored runtime condition.

5. The electronic device of claim 4, wherein the runtime condition comprises one of a memory bandwidth utilization, temperature, amount of power, or amount of processor compute cycles available.

6. The electronic device of claim 1, wherein the first execution data includes a first grouping of layers of the ML model and wherein the second execution data includes a second grouping of layers of the ML model.

7. The electronic device of claim 1, wherein the execution information includes third execution data indicating how to execute the ML model optimized based on the first performance criteria and the second performance criteria, and wherein the instructions further configure the one or more processors to:
determine to execute the ML model based on the first performance criteria and the second performance criteria; and
execute the ML model based on the third execution data.

8. A method comprising:
receiving a machine learning (ML) model and execution information associated with the ML model, wherein the execution information including first execution data indicating how to execute the ML model optimized based on a first performance criterion, and second execution data execution data indicating how to execute the ML model optimized based on a second performance criteria, the second performance criterion different from the first performance criteria;
executing the ML model based on the first execution data;
determining to execute the ML model based on the second execution data; and
executing the ML model based on the second execution data.

9. The method of claim 8, wherein the first performance criterion comprises an execution time of the ML model on the target hardware, and wherein the second performance criterion comprises a memory access bandwidth.

10. The method of claim 8, wherein the indication to execute the ML model based on the second execution data comprises the second execution data.

11. The method of claim 8, further comprising monitoring a runtime condition, wherein the determination to execute the ML model is based on the monitored runtime condition.

12. The method of claim 11, wherein the runtime condition comprises one of a memory bandwidth utilization, temperature, amount of power, or amount of processor compute cycles available.

13. The method of claim 8, wherein the first execution data includes a first grouping of layers of the ML model and wherein the second execution data includes a second grouping of layers of the ML model.

14. The method of claim 8, wherein the execution information includes third execution data indicating how to execute the ML model optimized based on the first performance criteria and the second performance criteria, and further comprising:
determining to execute the ML model based on the first performance criteria and the second performance criteria; and
executing the ML model based on the third execution data

15. A non-transitory program storage device comprising instructions stored thereon to cause one or more processors to:
receive a machine learning (ML) model;
generate first execution data for executing the ML model on target hardware, the first execution data indicating how to execute the ML model on the target hardware optimized based on a first performance criterion;
generate a second execution data for executing the ML model on target hardware, the second execution data indicating how to execute the ML model on the target hardware optimized based on a second performance criteria, the second performance criteria different from the first performance criterion; and
output the first execution data and second execution data for executing the ML model.

16. The non-transitory program storage device of claim 15, wherein the first performance criterion comprises an execution time of the ML model on the target hardware, and wherein the second performance criterion comprises a memory access bandwidth.

17. The non-transitory program storage device of claim 15, wherein the first execution data includes a first grouping of layers of the ML model and wherein the second execution data includes a second grouping of layers of the ML model.

18. The non-transitory program storage device of claim 15, further comprising:
preparing the ML for the target hardware by packaging the first execution data and the second execution data as a part of execution information associated with the ML model.

19. The non-transitory program storage device of claim 15, wherein the first execution data and second execution data are generated based on simulations of the ML model executing on the target hardware.

20. The non-transitory program storage device of claim 19, wherein the first execution data is generated by applying the first performance criterion to the simulations of the ML model and the second execution data is generated by applying the second performance criterion to the simulations of the ML model.
